(19) United States
(12) Patent Application Publication
(10) Pub. No.: US 2018/0022046 A1
(43) Pub. Date: Jan. 25, 2018

(54) Tire Repairing Plug, Kit Comprising Multiple Such Plugs, and Method Thereof

(71) Applicant: Kun Yuan Tong, Suwanee, GA (US)

(72) Inventor: Kun Yuan Tong, Suwanee, GA (US)

(21) Appl. No.: 15/679,150

(22) Filed: Aug. 16, 2017

Related U.S. Application Data
(63) Continuation-in-part of application No. 12/287,752, filed on Oct. 14, 2008, now abandoned.

(51) Int. Cl. B29C 73/06

(52) U.S. Cl. CPC B29C 73/06

(57) ABSTRACT

The present invention provides a tire repairing plug, a kit comprising a plurality of such plugs with different dimensions and designs to fit different tires and different damages thereon, and a method of using the plug to repair a damaged tire in vehicles such as bicycles, motorcycles, cars, and trucks etc. The plug incudes a cap and an elongated body, and a middle portion of the body is bigger than any other portions of the body. The invention exhibits numerous technical merits such as simpler operation, higher effectiveness and improved reliability in repairing a damaged tire, among others.

### CROSS-REFERENCE TO RELATED APPLICATIONS

This non-provisional application is a Continuation-in-Part of, and expressly claims the benefit of, U.S. Application with Ser. No. 12/287,752 filed Oct. 14, 2008 titled “Barrel formed bolt for repairing flat tire”, which is incorporated by references as if set forth in its entirety.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to a tire repairing plug, a kit or a tool box comprising a plurality of such plugs with different dimensions and designs to fit different tires and different damages thereon, and a method of using the plug to repair a damaged tire in vehicles such as bicycles, motorcycles, cars, and trucks etc.

### BACKGROUND OF THE INVENTION

During a trip, especially on highway where there is no auto-body shop nearby, it is very troublesome to repair a flat tire, because the flat tire has to be removed from wheel before it can be repaired. Moreover, a flat tire repair kit available on the market contains band rubbers, a tube of super glue and a needle, but it is also difficult to insert the band rubbers into nail hole with needle.

In the prior art, metal sheathing of aluminum has come into wide usage, and in applying the same, people have attempted to electrically insulate the securing elements or fastening elements employed, such as nails, screws, etc., from the aluminum, to avoid electrolytic action. People have also attempted to design structures providing an efficient and thorough sealing means to prevent entrance of moisture under the heads of the fasteners, since the moisture is likely to penetrate the sheathing about the fastener shanks and through the holes or openings formed in the sheathing as the fasteners are driven. Due to temperature changes, there is an expansion or contraction of the sheathing, people have attempted to make sealing means that is an elastomer or be compressible. This is to allow for such expansion without the loosening of the fastener in the under material into which they have been driven and whereby the seal remains effective by expansion of the sealing means on contraction of the sheathing. For example, U.S. Pat. No 2,724,303 issued to Holcomb provides a fastener such as nails and screws The fastener has on the shank thereof a coating adapted to peel back along the shank of the fastener as the shank is driven into an object. When the fastener is driven, the material comprising the coating is concentrated about that portion of the shank immediately under the fastener head and provides a seal between the fastener head and the object into or through which the fastener shank has been driven and also forms a seal between the shank and the hole formed by the latter as it is driven

U.S. Pat. No. 2,724,303 discloses some specific design of nails as shown in FIG. 1, and methods of using these nails as shown in FIG. 2. The nail 20 includes a shank 21 and a head 22. On an intermediate portion of the shank 21 is a coating 23 in the form of a band of the elastomer. However, coating 23 will peel or roll back along the nail shank as the latter is driven Coating 23 is free of the shank in that it is only supported thereby and is not tightly adhered or bonded thereto. In FIG. 1, wood screw 24 includes a head 25, a shank including a pointed end and a lower threaded portion 26 and an upper unthreaded, smooth portion 27 immediately under the head 25. On this smooth portion 27 is a coating 28 In use, as the screw 24 is threaded home, the coating 28 is rolled or peeled back and accumulates at the underside of the head 25 and about the extreme upper portion of the shank of the screw. In FIG. 1, machine screw 29 includes a head 30, a lower threaded shank portion 31 and an upper smooth or unthreaded shank portion 32 immediately under the head of the screw. On shank portion 32 is a coating 33. This machine screw is employed in the usual manner and when threaded home, the coating material peels or rolls back or up along the screw shank and accumulates at the underside of the screw head.

FIG. 2 illustrates the manner of how to use nail 20 As shown in FIG. 2, when such a nail 20 is driven, the coating material 23 will be peeled or rolled back and accumulate under the nail head and about the shank portion immediately under the nail head so as to form a seal as indicated by the accumulation (from A to B) of the coating of the nail 20 In FIG. 2, wood 14 is the siding of a building or the like. The same is covered by metal sheathing 15 which may be aluminum, copper, tin, etc. As the shank 21 of the nail is driven through the sheathing 15, a hole or opening 16 is formed in the latter. As the nail shank is driven inwardly, the elastomer coating 23 is entirely peeled back from the part of the shank penetrating the wood. As the driving of the nail 20 continues, the coating material 23 continues to peel or roll back along the nail shank 21 and in the final home position of the nail. This material is all accumulated under the head of the nail as at B The material is entirely about the nail shank and is shown as partly entered into opening 16 completely filling said opening about the nail shank and completely insulating the nail shank as well as the head of the nail from the sheathing.

U.S. Pat. No. 5,053,089 issued to Ristich provides a unitary threaded plug made of thermoplastic polymer composition for emergency tire repair As shown in FIG. 3, unitary plug 1 is circular in cross-section and tapered over the majority of its length to the finest practical point 2, forming a body 3. The untapered portion 4 at the top, or driving end, forms a head that has a shallowly concave contour 5 of its lateral silhouette which gives easy purchase for fingers to screw the plug into the puncture by hand. The larger untapered end portion, or head, has a greater diameter than the maximum diameter of the tapered portion, or body, affords increased mechanical advantage for torque applied with the fingers alone. The flat surface of the head 4 may be provided with a recess shaped for engagement by a tool such as a Philips head screwdriver for screwing the plug in. A coating such as asphalt coating may be pre-applied in manufacture, so that the repair procedure may omit a separate adhesive application step. The pre-applied coating provides means of safe self-rescue to the motorist, with a minimum of equipment and procedural steps. However, repairs made with this system enhanced by application of a moderate amount of rubber cement before insertion may be more leak-tight. Plug 1 is used by screwing it into the puncture opening in the tire T to a satisfactory depth, and thereafter the user removes most of the excess material of the plug left protruding outside the tire carcass, either by nipping it off with side-cutter pliers, by cutting it off with a utility knife, or by heating it with a match or a butane lighter, enough to soften a portion near the tire tread surface, and then twisting off the remainder with finger force, in any case leaving about one-quarter inch of material protruding

U.S. Pat. No. 594,066 issued to Cluxton teaches some means, devices, and appliances for repairing or closing and sealing punctures on pneumatic tires of cycles FIG. 4 shows a cross-section of a tire A and a plug partly elongated prior to insertion, the plug is then partly inserted; the plug is inserted and the tool is partly retracted; and the plug is inserted, cemented, and the tool is removed. Referring to FIG. 4, puncture 2 is designed to receive the plug 3, which comprises a tubular shank or stem 4, a hollow head 5, usually provided with an apex 6, and with perforations 7, opening into the chamber of said head and arranged in any suitable manner adjacent to the base of said stem. The apex 6 is created by adding stock at that point, and this protects the head against perforation by the tool 8 and also permits more ready entrance of the plug into the puncture. This tool may be a rod or the tubular nozzle of any suitable injector 9. It is inserted into the stem, the head having been lubricated by cement, and the apex applied to the puncture. Then the pressure upon said tool will elongate and stretch said head so that it will substantially lie against the sides of the tool for more ready or easier insertion. When inserted, the partial retraction of the tool will permit said head to resume its normal form transverse to said stem. Then the injection of cement into said head will cause it to flow through said perforations onto the face adjacent to the base of said stem. If the faces are then in contact, said cement will thereby be applied to both of them and the tool can be removed. This permits the tire to resume its normal condition and to expansively close the neck of the plug and the-opening therein, and the pressure of air forced into the tire will close the chamber in the head, force it tightly against the tire, force a modicum of cement into the neck of the stem, and the puncture is closed, cemented, and sealed. After this the projecting end of the stem can be cut off. The cement applied to lubricate the plug will coat the walls of the puncture and cement them to said stem. The cement is thus applied through the stem and head of the plug directly to the faces to be secured together, the neck of the stem closed and cemented, the walls of the chamber in the head are cemented together, and the walls of the puncture are cemented to the stem. Therefore, U.S. Pat. No. 594,066 provides a different means for closing, sealing, and repairing punctures in pneumatic tires. A repair plug is composed of a flexible hollow head mounted upon a tubular shank or stem and provided in its face, adjacent to the base of said stem, with perforations whereby the sealing cement can be applied to the face and to the interior face of the tire through said stem and head and its perforations. This plug is elastic, except as to the stem; but this is also expansible laterally. The head is elastic, so that by longitudinal pressure against its central portion it can be elongated and thereby reduced in size laterally, so as to be substantially of the size of the tool used, with the thickness of the material added, whereby it can be readily inserted through a small opening, and when the head is thus inserted and the tool is retracted slightly said head will re-expand into its normal shape. Then suitable cement is suitably forced through said stem into said head and through its perforations onto its outer face around said stem and onto the inner wall of the tire, and then said plug can be drawn out to bring it into close contact with the tire and the puncture is closed and the projection of the plug is then cut off.

U.S. Pat. No. 570,942 issued to Merritt discloses a plug or closing device for closing tube punctures. As shown in FIG. 5, a plug or closing device is inserted in the puncture in a rubber-tube wheel-tire T The plug may work with the screw for holding a driving plate or tool in position. A punch may be employed to prepare the puncture to receive the plug. Referring to FIG. 5, the closing device or plug P has a head or enlargement H at one extremity, and integral with it is a tapering portion having a helical groove g in its surface. The entering end e is of small diameter, and at the junction between the head H and the conical or tapering portion there is a circular groove G. The underside or undersurface of the head H is concave, as at C. The object of the groove G and concavity C is to provide a seat for the edge of the punctured tube-wall. The wall can be crowded into position by the wedge action due to the helical groove g, which, when the closing device is rotated, jams the rubber tube-wall into the groove G and cavity C, and the sharp edge of the concave head H enters or engages the outer surface of the tube T. The head of the closing device is drilled out and screw-threaded at t to receive a screw s. D is a slotted driving plate for attachment to the closing device or plug P, and is employed as a turning or driving tool for rotating the plug into position. The head H is slotted at 19 to receive a screw-driver end. When a rubber plug or tire is punctured, a user can cut a round hole at or near the center of the puncture and insert the plug half way, by screwing the driving tool D thereto. When the rubber tube is a wheel-tire, the user can next force air in to render the tube more rigid, and the user may then continue the rotation of the driving tool D until the edge of the concave head H engages the outer surface of the tube and until the helical groove in the surface has forced the edge of the rubber wall into the groove G and concavity C, which result is attained by making one or two turns after the edge of the head H engages the surface of the tube. The user may then disengage the turning or driving, tool, remove screw s, and complete the inflation of the tube T until it is rigid in the rim R. A punch B can be used for cutting a round hole at or near the center of the puncture. It has a sharp cutting edge 8 and a transverse perforation 9

Advantageously, the present invention provides a solution which is simpler but more effective than all the known devices and methods in the prior art.

### SUMMARY OF THE INVENTION

One aspect of the present invention provides a plug for repairing a flat tire. The plug includes a cap and an elongated body extending from a proximal end that is connected to or integrated with the cap to a distal end. The elongated body is circular in cross section and has a rotational axis along the elongation direction. The elongated body has cross sectional diameter Dx at a position Px along the rotational axis, and distance Lx is defined as a distance from the proximal end to positon Px along the rotational axis. Therefore, the proximal end is at position P0 with L0=0 and has a cross sectional diameter D0≠0. The distal end is at position Pd with Ld (maximal value of Lx) and has a cross sectional diameter Dd which is near 0. Mathematically speaking, one feature of the invention is that a cross sectional diameter Dm at position Pm with Lm is greater than cross sectional diameters at any other positions along the rotational axis. Moreover, diameter Dm at position Pm remains unchanged after the flat tire repairing is completed. In other words, the plug is not deformed at all after the flat tire repairing is completed.

Another aspect of the invention provides a method of repairing a flat tire using the plug as described above. The method includes the following steps: (1) providing a plug as described above, (2) applying a coating onto the elongated body of the plug, and (3) inserting the entire elongated body into a nail hole of said flat tire from external side of the tire. The cap of the plug remains at external side of the tire after a complete insertion of the elongated body. Step (4) is curing or solidifying the coating, and step (5) is inflating the repaired flat tire to normal pressure.

Still another aspect of the invention provides a flat tire repairing kit comprising a plurality of the plugs as described above. At least two of the plugs in the kit have different Dm values and/or different Lm values, to fit different tires and different damages thereon.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form, omitted, or merely suggested, in order to avoid unnecessarily obscuring the present invention.

FIG. 1 shows various sealing nails in the prior art.

FIG. 2 illustrates how to use the sealing nails of FIG. 1 in the prior art.

FIG. 3 shows a unitary threaded plug for emergency tire repair in the prior art.

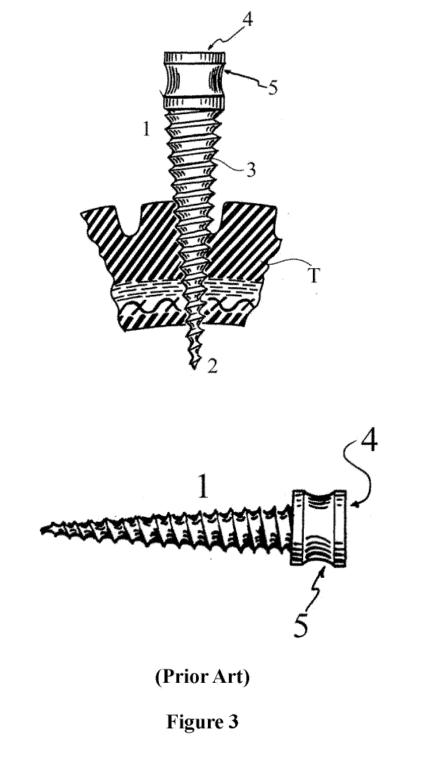

FIG. 4 shows a cross-section of a tire and another plugging device in the prior art.

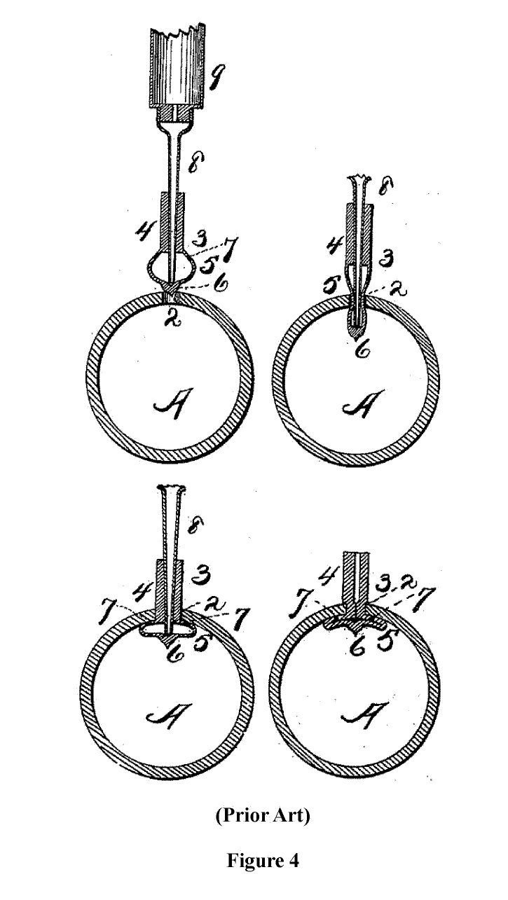

FIG. 5 shows a plug or closing device being inserted in the puncture in a rubber-tube wheel-tire in the prior art.

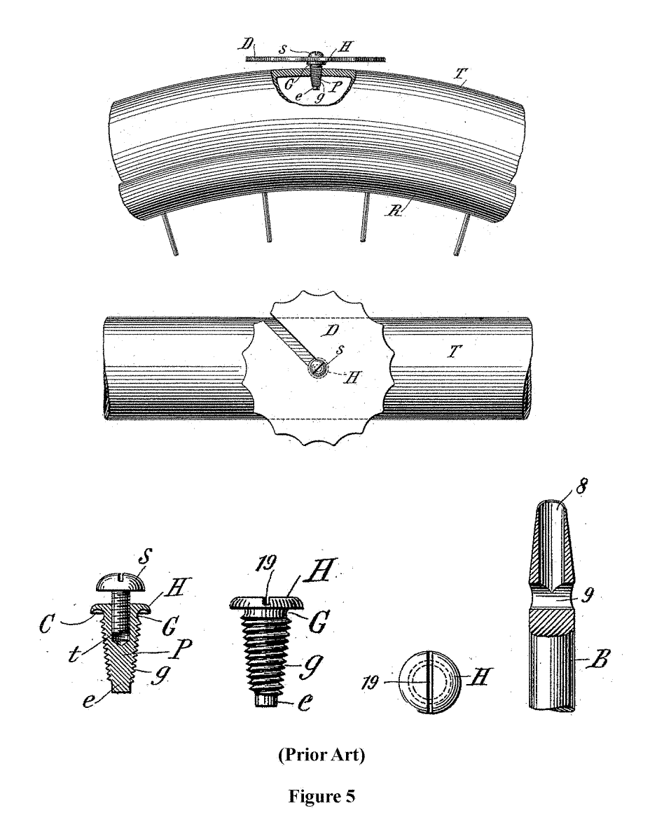

FIG. 6 illustrates a flat tire repairing plug in accordance with an exemplary embodiment of the present invention.

FIG. 7 demonstrates a flat tire repairing plug in accordance with an exemplary embodiment of the present invention.

FIG. 8 depicts a method of repairing flat tire in accordance with an exemplary embodiment of the present invention.

FIG. 9 schematically shows a flat tire repairing kit in accordance with an exemplary embodiment of the present invention.

FIG. 10 illustrates two specific designs of flat tire repairing plug in accordance with an exemplary embodiment of the present invention.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

It is also to be understood that the terminology used herein is for the purpose of describing particular embodiments only, and is not intended to limit the scope of the invention. For example, when an element is referred to as being “on”, “connected to”, or “coupled to” another element, it can be directly on, connected or coupled to the other element or intervening elements may be present. In contrast, when an element is referred to as being “directly on”, “directly connected to”, or “directly coupled to” another element, there are no intervening elements present.

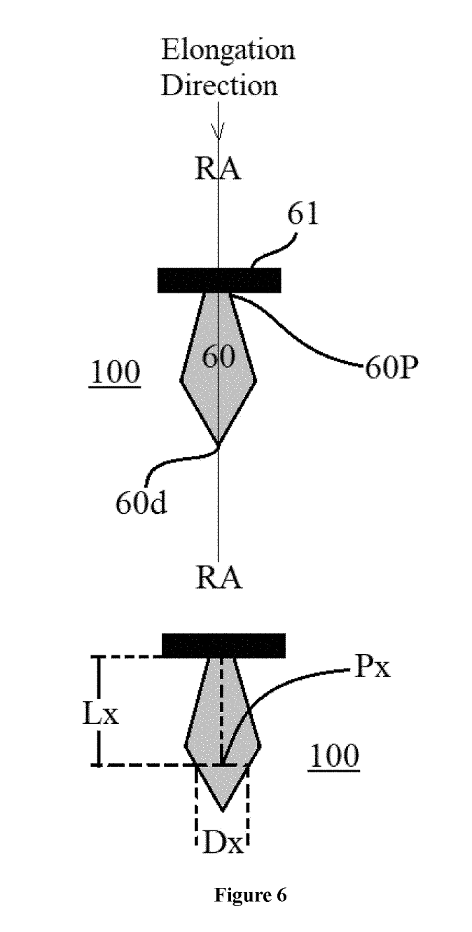

Referring to FIG. 6, plug 100 is designed for repairing punctured tubes or pipes of flexible material, like rubber (e.g. a flat tire) by closing the aperture therein. These tubes are usually expanded by air under pressure, and often become punctured in use at a distance from convenient facilities for repairing. The punctures in tubes usually occur in the form of slits or slots and are produced by winning over a fragment of glass or stone having a ragged cutting edge As will be explained in details, plug 100 enables a quick repair to a tire in side-of-the-road self-rescue, without the need for removing either the tire or the rim from the vehicle.

Referring to FIG. 6, plug 100 includes a cap 61 and an elongated body 60 extending from a proximal end 60P that is connected to or integrated with the cap 61 to a distal end 60d (or entering end into a tire). The elongated body 60 is circular in cross section (irregularity such as grooves, if any, on the body will be ignored or approximated for simplicity of this model and its description) and has a rotational axis RA along the elongation direction. Elongated body 60 has cross sectional diameter Dx at a position Px along the rotational axis RA. Distance Lx is defined as a distance measured from the proximal end 60P to positon Px along the rotational axis RA.

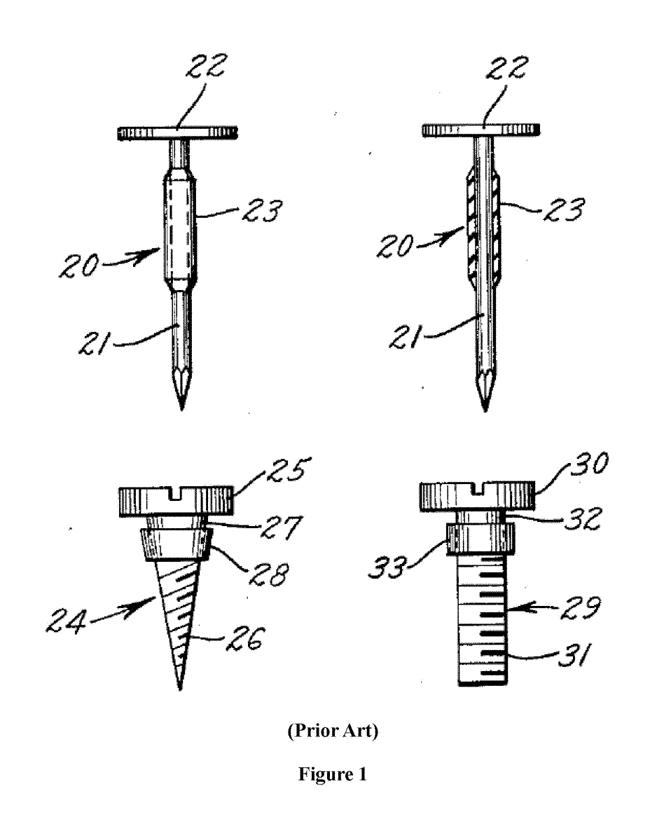

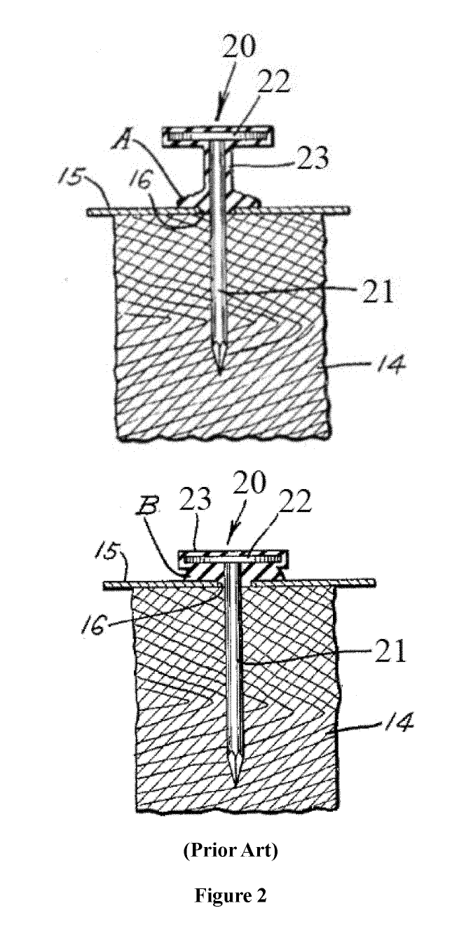

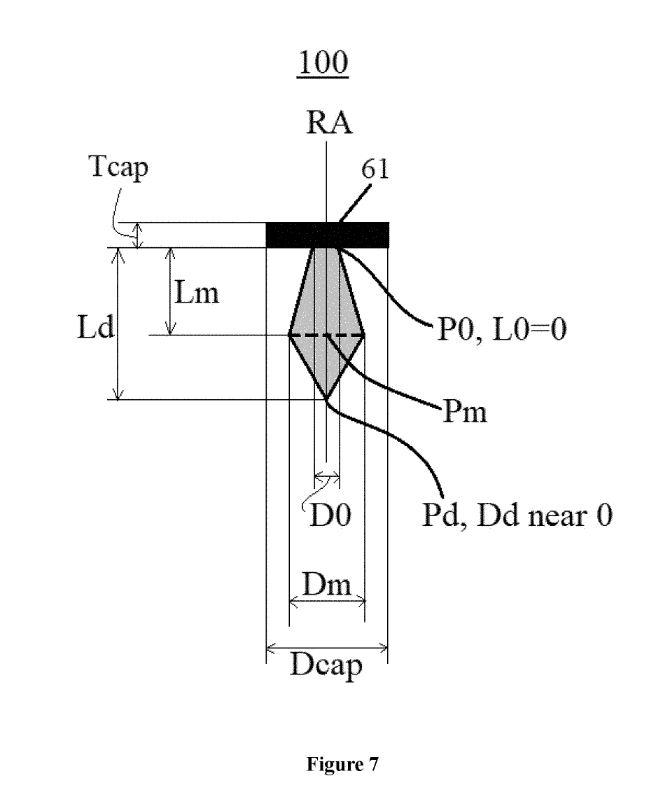

In this model, the proximal end 60P is at position P0 with L0=0 and has a cross sectional diameter D0≠0, as shown in FIG. 7. The distal end 60d is at position Pd with Ld and has a cross sectional diameter Dd which is near 0. At position Pm with Lm (in other words, when Lx=Lm), there exists a corresponding cross sectional diameter Dm, which is greater than cross sectional diameters at any positions other than Pm along the rotational axis RA. In preferred embodiments, diameter Dm at position Pm remains unchanged after the flat tire repairing is completed. For example, the entire body 60 may be a single piece made of iron, steel or any other sufficiently rigid polymeric material, and it maintains its structural integrity after the tire repairing process. Therefore, when the plug 100 is driven inwardly into a tire, the mass in positon 60m region will not be peeled or rolled back, which is different from elastomer coating 23 as shown in FIGS. 1 and 2. There is no specific requirement for cap 61. Cap 61 and body 60 may be single integrated piece, or they may be two pieces secured to each other. For example, the cap 61 may be round with a thickness Tcap and a diameter Dcap. Generally, Dcap is greater than both D0 and the size of the hole on the tire that is to be repaired.

In various embodiments, diameter Dx monotonously increases from D0 at the proximal end P0 to Dm at position Pm, and then monotonously decreases from Dm to Dd at distal end Pd In other words, body 60 is tapering along two directions (up and down along RA) from position Pm In preferred amendments, Lm is greater than 50% of Ld, greater than 60% of Ld, greater than 70% of Ld, greater than 80% of Ld, or greater than 90% of Ld. Dm is greater than D0, for example, Dm may be greater than 1.5D0, 2.0D0, 2.5D0, 3.0D0, 3.5D0, or higher

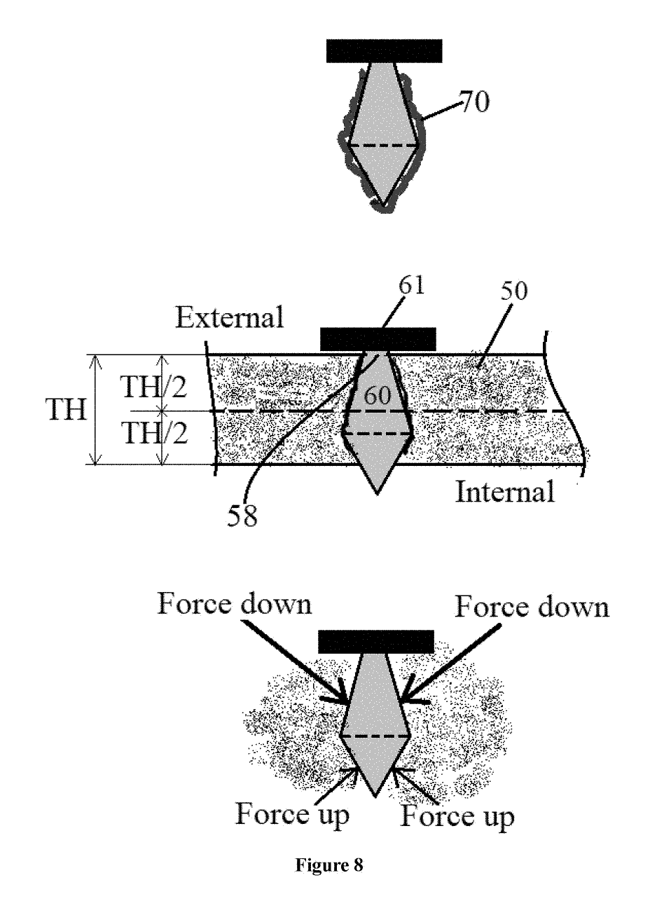

FIG. 8 illustrates a method of repairing a flat tire 50 using the plug 100. The method includes (1) providing a plug 100, (2) applying a coating 70 such as rubber cement onto the elongated body 60, and (3) inserting the elongated body 60 into a nail hole 58 of said flat tire 50 from external side of the tire 50. Cap 61 remains at external side of the tire 50 after the insertion. Step (4) is curing or solidifying the coating 70, so that coating 70 adheres or bonds body 60 and the tire material together. Step (5) is inflating the repaired flat tire 50 to normal pressure

A suitable plug 100 may always be selected for a tire of any dimension and thickness. For example, if the tire 50 has a thickness TH, then a plug with Lm greater than 50% TH may be preferably selected to repair the flat tire. Lm may be greater than 50% TH, 60% TH, 70% TH, 80% TH, or 90% TH. As shown in FIG. 8, when Lm is greater than 50% TH, position Pm will pass the half thickness line of the tire TH/2. As a result, the “force down” from the elastic tire material imposed on body 60, which pushes the plug 100 inwardly, will be greater than the “force up” from the elastic tire material imposed on body 60, which pushes the plug 100 outwardly. Therefore, plug 100 is sturdily stabilized and maintained inside the tire material.

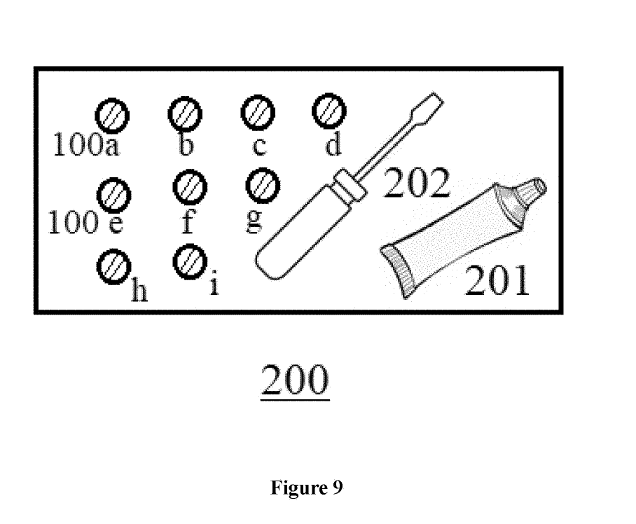

As shown in FIG. 9, the present invention also provides a kit like a tool box 200 comprising a plurality of the plugs 100a, b, c, d, e, f, g, h, i, and etc. At least two of the plugs selected from 100a, b, c, d, e, f, g, h, i have different Dm values and/or different Lm values. The kit may further includes a container 201 containing a curable coating material 70, and a tool 202 for driving the plug 100 into the hole 58. Kit 200 occupies a small space, and can be quickly applied without the use of special tools, in exposed and otherwise inconvenient locations.

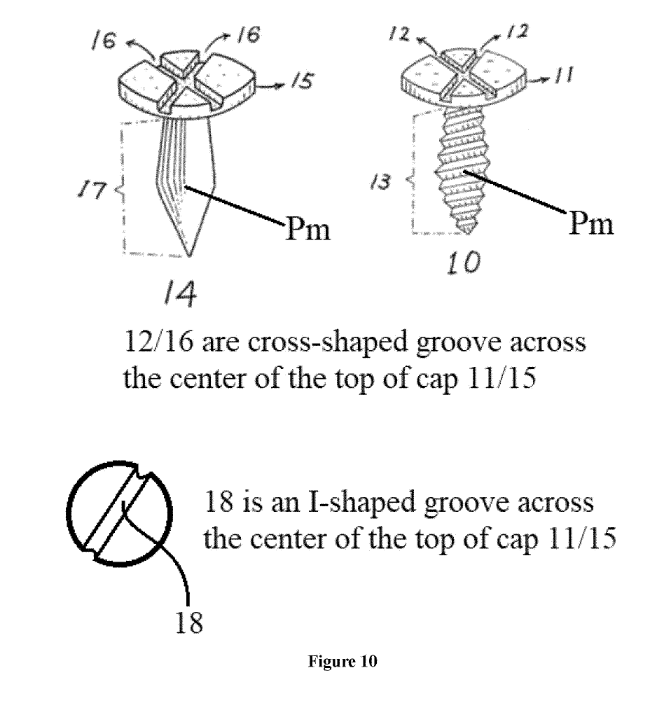

FIG. 10 illustrates two specific embodiments of plug 100 having a cap and a barrel formed body (as screw or pin, as example of body 60) wherein diameter of middle of said body (Dm) is wider than diameter of either end of said body. The cap may be a flat top, or it can have a drive design across the middle of the top, such as cross-shaped groove, I-shaped groove (as shown in top view of FIG. 9) across the middle of the cap top. FIG. 10 shows a barrel-forming screw 10 including cap 11, cross-shaped groove 12 or I-shaped groove 18 on the top of cap 11, and barrel forming crew body 13 (example of body 60). FIG. 10 also shows a barrel forming nail 14 including nail cap 15, cross-shaped groove 16 or I-shaped groove 18 on the top of nail cap 15, and barrel forming nail body 17 (another example of body 60).

Before the insertion of barrel formed screw 10 or barrel formed nail 14 into the nail hole of a flat tire, a user can apply coating material 70 such as super glue to barrel formed screw 10 or barrel formed nail 14 for lubrication to facilitate the insertion and to create an airtight sealing. Because of the form/shape of barrel of barrel formed screw 10 or barrel formed nail 14, and the adhesion of super glue it is very hard for barrel formed screw 10 or barrel formed nail 14 to become loose. By driving car forward or backward slowly inch by inch, one can turn nail hole on flat tire to face the back of car. Once turning nail hole on a flat tire to face the back of car, the user lubricates the barrel formed screw 10 or barrel formed nail 14 with super glue and inserts or hammers it into the nail hole of the flat tire while the tire is still on wheel. After the insertion of barrel formed screw 10 or barrel formed nail 14, the user can wait for a couple of minutes to let super glue set before he/she inflates the repaired flat tire. A flat tire repair kit (as example of kit 200) may contain a barrel formed screw, a barrel formed nail, a tube of super glue, and a screw driver. Barrel formed bolt can be of a variety of size, which is not shown in, but can be inferred from FIG. 9. The barrel formed screw or barrel formed nail can be used temporarily to repair a flat tire before the nail hole can be repaired by a machinist at auto body shop. The barrel shaped screw or barrel shaped nail can stay permanently on tire if air leakage of tire does not reoccur.

In the foregoing specification, embodiments of the present invention have been described with reference to numerous specific details that may vary from implementation to implementation. The specification and drawings are, accordingly, to be regarded in an illustrative rather than a restrictive sense The sole and exclusive indicator of the scope of the invention, and what is intended by the applicant to be the scope of the invention, is the literal and equivalent scope of the set of claims that issue from this application, in the specific form in which such claims issue, including any subsequent correction.

1. A plug for repairing a flat tire, comprising:
a cap, and
an elongated body extending from a proximal end that is connected to or integrated with the cap to a distal end,
wherein the elongated body is circular in cross section and has a rotational axis along the elongation direction;
wherein the elongated body has cross sectional diameter Dx at a position Px along the rotational axis;
wherein distance Lx is defined as a distance from the proximal end to positon Px along the rotational axis,
wherein the proximal end is at position P0 with L0=0 and has a cross sectional diameter D0≠0, and the distal end is at position Pd with Ld and has a cross sectional diameter Dd which is near 0;
wherein a cross sectional diameter Dm at position Pm with Lm is greater than cross sectional diameters at any positions other than Pm along the rotational axis; and
wherein diameter Dm at position Pm remains unchanged after the flat tire repairing is completed.

2. The plug according to claim 1, wherein diameter Dx monotonously increases from D0 at the proximal end P0 to Dm at position Pm, and then monotonously decreases from Dm to Dd at distal end Pd.

3. The plug according to claim 1, the entirety of which is made of iron or steel.

4. The plug according to claim 1, wherein Lm is greater than 50% of Ld.

5. The plug according to claim 1, wherein Lm is greater than 60% of Ld.

6. The plug according to claim 1, wherein Lm is greater than 70% of Ld.

7. The plug according to claim 1, wherein Lm is greater than 80% of Ld.

8. The plug according to claim 1, wherein Lm is greater than 90% of Ld.

9. The plug according to claim 1, wherein the cap has a flat top.

10. The plug according to claim 1, wherein the cap has a drive design across the center of the top for driving or inserting the plug into a damaged site of a tire.

11. The plug according to claim 10, wherein the driving design is cross-shaped groove across the center of the top.

12. The plug according to claim 10, wherein the driving design is I-shaped groove across the center of the top.

13. A method of repairing a flat tire using the plug of claim 1, comprising:
(1) providing a plug of claim 1,
(2) applying a coating onto the elongated body of the plug,
(3) inserting the elongated body into a damaged site of said flat tire from external side of the tire, wherein the cap remains at external side of the tire,
(4) curing or solidifying the coating, and
(5) inflating the repaired flat tire to normal pressure.

14. The method according to claim 13, wherein the damaged site is a nail hole.

15. The method according to claim 13, wherein the tire has a thickness TH, and the plug has a Lm value greater than 50% TH.

16. The method according to claim 13, wherein the tire has a thickness TH, and the plug has a Lm value greater than 60% TH.

17. The method according to claim 13, wherein the tire has a thickness TH, and the plug has a Lm value greater than 70% TH.

18. A kit for repairing a flat tire, comprising a plurality of the plugs according to claim 1, wherein at least two of the plugs have different Dm values and/or different Lm values.

19. The kit according to claim 18, further comprising a container containing a curable coating, material.

20. The kit according to claim 18, further comprising a tool such as a screw driver for driving the plug into a damaged site of the tire.
